(19) United States
(12) Patent Application Publication
(10) Pub. No.: US 2022/0086124 A1
(43) Pub. Date: Mar. 17, 2022

(54) PROCESSING DATA

(71) Applicant: NUM Technology Ltd, London (GB)

(72) Inventor: Elliott Michael BROWN, London (GB)

(21) Appl. No.: 17/538,450

(22) Filed: Nov. 30, 2021

Related U.S. Application Data
(63) Continuation of application No. PCT/GB2020/051323, filed on Jun. 2, 2020.

(30) Foreign Application Priority Data
Jun. 7, 2019 (GB) 1908168.6

(51) Int. Cl. H04L 101/604; H04L 61/4511; H04L 101/30

(52) U.S. Cl. CPC H04L 61/6004; H04L 61/303; H04L 61/1511

(57) ABSTRACT

Data is processed using a hierarchical domain name system. A domain name system query for a first domain name is transmitted via a network. The first domain name comprises a second domain name and at least one label preceding the second domain name. The at least one label comprises data obtained based on a third domain name having been processed using a domain name modification operation. A response to the domain name system query for the first domain name is received via the network. The response comprises one or more resource records comprising information associated with the third domain name. The response to the domain name system query for the first domain name is processed. The processing of the response comprises identifying the information associated with the third domain name in the one or more resource records.

### CROSS-REFERENCE TO RELATED APPLICATIONS

This application is a continuation of International Application No. PCT/GB2020/051323, filed Jun. 2, 2020 which claims priority to GB Application No. GB1908168.6, filed Jun. 7, 2019, under 35 U.S.C. § 119(a). Each of the above-referenced patent applications is incorporated by reference in its entirety.

### BACKGROUND

### Technical Field

The present disclosure relates to processing data.

### Background

The “.uk” top-level-domain (TLD) is a zone run by Nominet, which serves resource records for around 2,000,000 domain names in “.uk”, included in these resource records are NS records for “.co.uk”, “.org.uk”, “me.uk” and others. These zones contain resource records for around 10,000,000 more domain names. The “.com” TLD is currently the biggest and serves out around 180,000,000 resource records.

Information (for example, contact information) associated with one domain name (for example, the domain name “example.com”) may be stored in a resource record having a resource record label “example.com” in a zone file for a different domain name (for example, the domain name “lookup.nomserver.com”). Examples of such contact information include, but are not limited to, telephone numbers, e-mail addresses etc. Such information may be obtained via a domain name system by a requesting entity performing a domain name system query for the domain name “example.com.lookup.nomserver.com”. An authoritative name server for the domain name “lookup.nomserver.com” would identify the resource record with the resource record label “example.com” in the zone file for the domain name “lookup.nomserver.com” and serve that resource record to the requesting entity. In this regard, the reader is referred to International patent application no. PCT/GB2016/054051, the entire contents of which are incorporated herein by reference.

Such a zone file may include a significant number of resource records where information associated with a significant number of domain names is stored in this way. The size of the zone file may become very large as many such resource records are created and added to the zone file. Larger zone files can be more difficult to maintain than smaller zone files. In addition, the maximum number of resource records that can be included in a single zone file may be limited to a relatively low number. For example, a cloud-based domain name system may restrict the number of resource records that can be stored in a single zone file to a maximum of 10,000. Such a system cannot therefore readily be used to serve out a significant number of resource records, in excess of 10,000, from a single zone file. For example, storing information associated with every domain name that is already registered, plus future domain name registrations, may involve the use of billions of such resource records. This would far-exceed the 10,000 resource record limit for a single zone file in a cloud-based domain name system.

### SUMMARY

According to first embodiments, there is provided a method of processing data using a hierarchical domain name system, the method comprising:
transmitting, via a network, a domain name system query for a first domain name, the first domain name comprising a second domain name and at least one domain name label preceding the second domain name, the at least one domain name label comprising data obtained based on a third domain name having been processed using a domain name modification operation;
receiving, via the network, a response to the domain name system query for the first domain name, the response comprising one or more resource records comprising information associated with the third domain name; and
processing the response to the domain name system query for the first domain name, said processing of the response comprising identifying the information associated with the third domain name in the one or more resource records.

According to second embodiments, there is provided a method of processing data using a hierarchical domain name system, the method comprising:
receiving, via a network, a domain name system query for a first domain name, the first domain name comprising a second domain name and at least one domain name label preceding the second domain name, the at least one domain name label comprising data obtained based on a third domain name having been processed using a domain name modification operation;
processing the domain name system query for the first domain name, said processing comprising obtaining one or more resource records comprising information associated with the third domain name; and
transmitting, via the network, a response to the domain name system query for the first domain name, the response comprising the one or more resource records comprising the information associated with the third domain name.

According to third embodiments, there is provided a method of processing data using a hierarchical domain name system, the method comprising:
processing a resource record in response to a domain name system query for a first domain name, the first domain name comprising a second domain name, a third domain name, and at least one domain name label between the second and third domain names, the at least one domain name label comprising data obtained based on the third domain name having been processed using a domain name modification operation, the resource record comprising information associated with the third domain name.

According to fourth embodiments, there is provided a method of processing data using a hierarchical domain name system, the method comprising:
causing a plurality of child zones of a parent zone to be created;
causing information associated with a given domain name to be stored in a zone file for one of the plurality of child zones, a left-most label of the one of the plurality of child zones comprising data derived based on the given domain name having been processed using a domain name distribution operation;
causing, for each of the plurality of child zones, a plurality of further child zones to be created; and
causing the information associated with the given domain name to be stored in a zone file for one of the plurality of further child zones, a left-most label of the one of the plurality of further child zones comprising data derived based on the given domain name having been processed using the domain name distribution operation.

According to fifth embodiments, there is provided a method of processing data using a hierarchical domain name system, the method comprising:
obtaining a domain name;
hashing the obtained domain name to generate hashed data in a first base;
converting the obtained hashed data in the first base to a second, higher base to generate base-converted data in the second, higher base;
selecting one or more characters of the base-converted data in the second, higher base;
transmitting a domain name system query comprising at least the selected one or more characters; and
receiving, in response to the transmitted domain name system request, a response, the response comprising information associated with the domain name.

According to sixth embodiments, there is provided apparatus arranged to perform a method according to any of the first to fifth embodiments.

According to seventh embodiments, there is provided a computer program arranged, when executed, to perform a method according to any of the first to fifth embodiments.

According to eighth embodiments, there is provided a computer-readable medium comprising a computer program according to the seventh embodiments.

Further features and advantages will become apparent from the following description, given by way of example only, which is made with reference to the accompanying drawings.

### BRIEF DESCRIPTION OF THE DRAWINGS

FIG. 1 shows a schematic block diagram of an example of a hierarchical domain name system;

FIG. 2 shows a schematic block diagram of an example of a data communications network in accordance with embodiments;

FIG. 3 shows a schematic block diagram of another example of a data communications network in accordance with embodiments;

FIGS. 4A and 4B show a sequence diagram illustrating an example of a method in accordance with embodiments; and

FIG. 5 shows a schematic block diagram of an example of an apparatus in accordance with embodiments.

### DETAILED DESCRIPTION

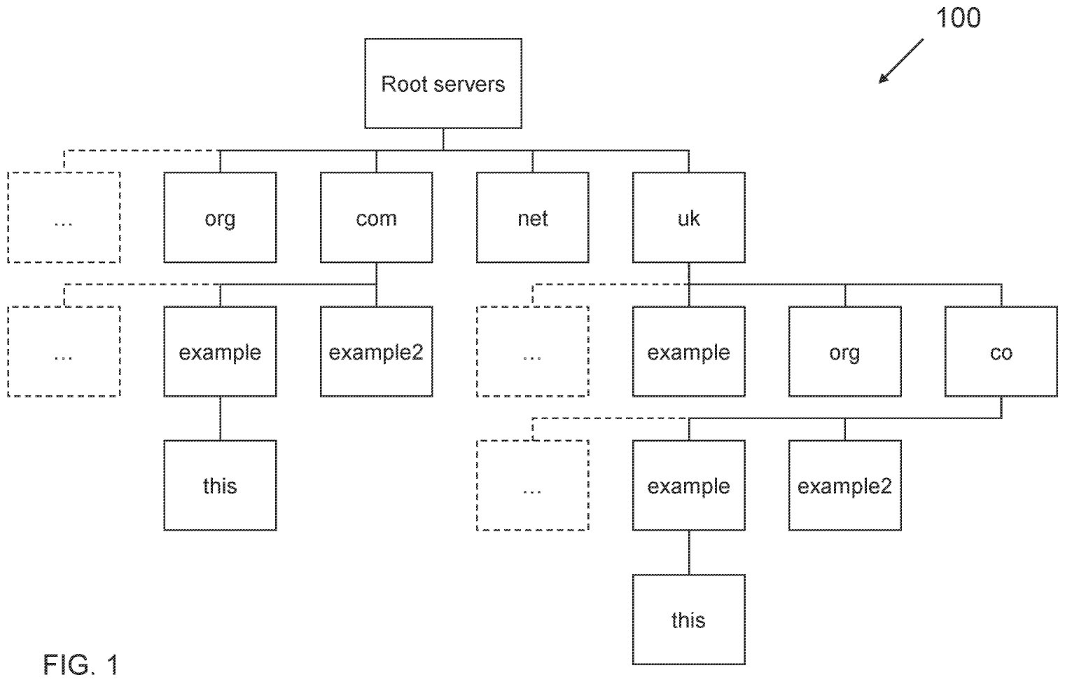

Referring to FIG. 1, there is shown schematically an example of a hierarchical domain name system 100. In this example, the hierarchical domain name system is the Domain Name System (DNS).

The DNS is a global, distributed, hierarchical naming system for resources connected to computer networks. DNS is detailed, for example, in IETF RFC 1034 and 1035. One function of the DNS is to translate human-friendly domain names into machine-friendly Internet Protocol (IP) addresses. For example, the DNS may translate a human-friendly domain name of “example.com” into a machine-friendly IP address of 123.45.67.89. The DNS serves as the directory service of the Internet.

Every domain name on the Internet is part of the DNS. The DNS is the cornerstone of the Internet and was created to make the Internet easier to use. The DNS translates easy-to-remember domain names into IP addresses of IP devices, such as servers. The DNS is used every day by billions of people. The DNS is used each time someone enters a domain name into their web browser. The DNS tells a web browser which web server to go to when a website, for example “example.com”, is requested, for example on a computer or smartphone.

Every domain name is hosted on a DNS server. There are many thousands of DNS servers operating worldwide. Information about a domain name is stored in a zone file on a DNS server. A zone file contains DNS resource records. The DNS is made up of name servers that hold information about domain names in DNS zones. Information for each domain name is held in a zone file. Included within the zone file are DNS resource records.

At the highest level of the DNS hierarchy are the root name servers. The root name servers list the authoritative name servers for TLDs. Examples of TLDs include, but are not limited to, “com” and “uk”.

In the domain name “this.example.com”, the following are all domain names: “this.example.com”, “example.com” and “com”. “com” is a TLD. In addition to being a domain name, “example.com” is a sub-domain of the TLD “com”, and “this.example.com” is a sub-domain of the domain name “example.com”. Each of the parts of a domain name separated by a dot is called a label. Such a label is sometimes referred to herein as a “domain name label”. In the domain name “this.example.com”, “this”, “example” and “com” are labels.

In the domain name “this.example.co.uk”, the following are all domain names: “this.example.co.uk”, “example.co.uk”, “co.uk” and “uk”. “uk” is a country code TLD (ccTLD). In addition to being a domain name, “co.uk” is a sub-domain of the ccTLD “uk”, “example.co.uk” is a sub-domain of the domain name “co.uk” and “this.example.co.uk” is a sub-domain of the domain name “example.co.uk”. In the domain name “this.example.co.uk”, “this”, “example”, “co” and “uk” are all domain name labels.

Domain name labels are not necessarily domain names. For example, the domain name label “this” in the examples above is not a domain name since it is not resolvable in the DNS. Strictly speaking, all domain names end in a dot. This is known as a fully qualified domain name (FQDN). In practice, “this.example.co.uk” is “this.example.co.uk.” in the DNS. The final dot represents the DNS root zone. However, since the final dot is always included in a DNS query, the final dot can be omitted by a user and a DNS client or resolver can add it. Many webservers do not deal well with the final dot, however.

A TLD (or “name space”) is managed by a Domain Registry (hereinafter “Registry”). For example, VeriSign is the Registry that manages the “com” name space. Nominet is the Registry that manages the “uk” name space. Some Registries have split their domain name into sub-domains. For example, Nominet has split their TLD “uk” into “co.uk”, “org.uk”, “me.uk” and others. Nominet allows the creation of domain names at the second level under “uk” in the format of “example.uk”. Creating new domains within a name space is known as a domain name registration.

Although domain names can sometimes be registered directly through Registries, this is discouraged and registration of domain names within the Registry name space is typically through Domain Registrars (hereinafter “Registrars”). A person registering a domain name (e.g. “example.com”) through a Registrar is known as a Registrant. A registrant is allowed to set up further domain names (a sub-domain) within their domain (e.g. this.example.com).

Every domain name has an authoritative name server. An authoritative name server is the name server that holds the current DNS resource records for the domain name. There are various types of DNS resource record. One type of resource record is a Name Server (NS) record. An NS resource record is used to delegate authority for a DNS zone to another name server. The most common DNS resource record is an “A” record. An A record is used to direct website requests to IP addresses. There are other DNS resource record types including, but not limited to, Mail Exchange (MX) records for e-mail, records for free text (TXT) along with other record types.

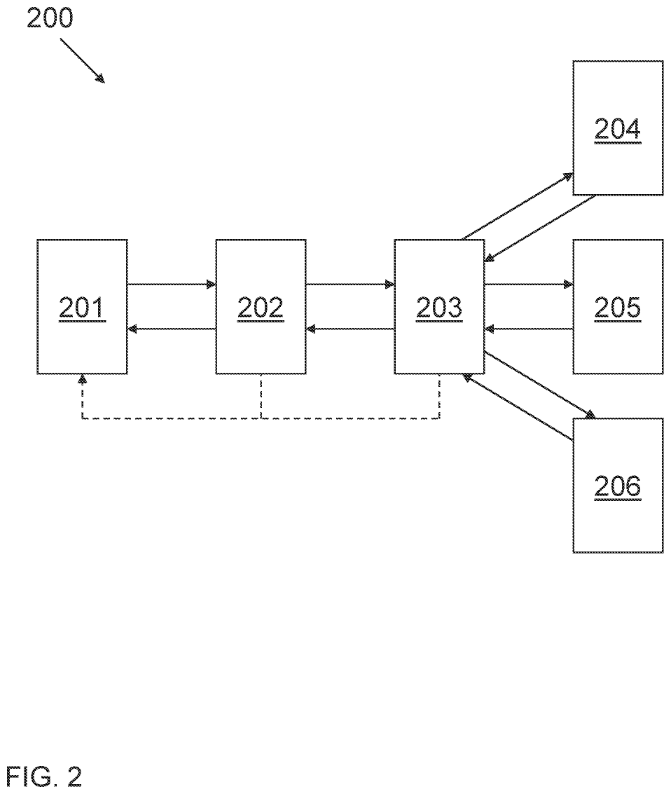

Referring to FIG. 2, there is shown schematically an illustration of an example of a data communications network 200.

The data communications network 200 includes a user device 201. The user device is associated with a user. Examples of user device 201 include, but are not limited to, a smartphone, a tablet computing device, a laptop computer, a desktop computer, a satellite navigation device, an in-vehicle entertainment system and a smart television. The data communications network 200 also includes a local network 202. The local network 202 includes one or more components. An example of a component of the local network 202 is a router. The communications network 200 also includes a DNS resolver 203 at an Internet Service Provider (ISP) of the user. The communications network 200 also includes a root server 204. The communications network 200 also includes a registry name server 205. In this example, the registry name server 205 is an authoritative name server of the top-level domain name “com”. The communications network 200 also includes a registrant name server 206. In this example, the registrant name server 206 is an authoritative name server of the domain name “example.com”.

The process of finding DNS resource records for a domain name is known as DNS resolution or domain name resolution. DNS resolvers are used for this purpose. DNS resolvers determine the authoritative name servers for a given domain name by resolving the full domain name starting with the right-most label and working to the left-most label in the domain name.

In this example, a user enters the domain name “example.com” into a web browser on their user device 201.

If the domain name has been resolved recently, DNS resource records previously retrieved for the domain name will be stored in the user device 201 DNS cache or in the local network 202 DNS cache and will be returned to the user device 201.

If the domain name “example.com” has not been resolved recently, for example if an IP address for the domain name “example.com” is not cached in the local network 202, then the DNS query is passed to the DNS resolver 203.

In this example, the DNS resolver 203 performs recursive DNS lookups, starting with the label “com”. The DNS resolver 203 resolves the domain name starting with the right-most label first and requests the IP address for the authoritative name server 205 for the “com” TLD from the root server 204. The IP address for the authoritative name server 205 for the “com” domain name is returned from the root server 204.

The DNS resolver 203 queries the authoritative name server 205 for the domain name “com” for the IP address of the authoritative name server 206 of the domain name “example.com”.

The authoritative name server 205 for the domain name “com” returns the IP address of the authoritative name server 206 for the domain name “example.com” to the DNS resolver 203. In this example, the authoritative name server 206 for the domain name “example.com” is the name server elected by the Registrant of the domain name “example.com” when they registered their domain name “example.com”.

As the DNS resolver 203 has reached the left-most label of the domain name “example.com”, the DNS resolver 203 requests the DNS resource records for the domain name “example.com” from the authoritative server 206 for the domain name “example.com”. The DNS resolver 203 returns an error if no resource records were found.

Assuming resource records were found for the domain name “example.com”, an IP address of a web server associated with the domain name “example.com” is returned to the DNS resolver 203 in the resource records for the domain name “example.com”. The DNS resolver 203 caches the resource records.

The DNS resolver 203 returns the resource records to the local network 202.

The local network 202 caches the resource records.

The local network 202 returns the resource records to the user device 201. The user device 201 caches the resource records. The web browser running on the user device 201 sends a request to the IP address for the web server associated with the domain name “example.com” over Hypertext Transfer Protocol (Secure) (HTTP(S)) for website HTML content for the domain name “example.com”. The IP address for the web server associated with the domain name “example.com” was included in the resource records returned by the DNS resolver 203.

As indicated above, the resource records retrieved for the domain name “example.com” are cached on the user device 201, in the local network 202 and by the DNS resolver 203 for a specified time. The specified time is determined by a Time-to-live (“TTL”) setting of the resource record that was returned.

A DNS query is often sent to a name server using User Datagram Protocol (UDP) on port 53. A DNS query can also travel over Transmission Command Protocol (TCP). DNS over HTTP (DoH) enables a client to send a DNS query to a resolver over HTTP or HTTPS. A response to a DNS query from a name server includes an answer to the query. The answer comes from a DNS zone file, which lists the resource records for the domain name. Every domain name is listed in an associated zone file; even TLDs.

The format of a DNS zone file is defined in RFC 1035 (section 5) and RFC 1034 (section 3.6.1). This format was originally used by the Berkeley Internet Name Domain (BIND) software package, but has been widely adopted by other DNS servers. A zone file is a sequence of entries of resource records. Each line in the zone file is a text description that defines a single resource record. The text description comprises several fields separated by white space as follows:
NAME TTL CLASS TYPE DATA

An example entry in a zone file for the example domain name “example.com” is:

| NAME | TTL | CLASS | TYPE | DATA |
|---|---|---|---|---|
| example.com. | 270 | IN | A | 123.45.67.89 |

The TTL value indicates how long the record should be cached for, which, in this example, is 270 seconds.

An example of a DNS query for any DNS resource record type for the example domain name “example.com” generated using the “dig” command line tool is:
dig example.com ANY

Many name servers do not respond to DNS queries requesting “ANY” type of resource record. For such name servers, a resource record type is to be specified.

An example of a response received from a name server for the domain name “example.com” is:

| | | | | |
|---|---|---|---|---|
| example.com. | 270 | IN | A | 123.45.67.89 |
| example.com. | 194 | IN | MX | 10 mailserver.com |
| example.com. | 91816 | IN | NS | ns1.nameserver.com. |
| example.com. | 91816 | IN | NS | ns2.nameserver.com. |
| example.com. | 1840 | IN | TXT | “v = spfl ip4 123.45.67.89 − all” |

In this example, the DNS query for the domain name “example.com” has returned five resource records. Each resource record is displayed on its own line. The first resource record, displayed on the first line, is an A record showing the IP address of the server that handles HTTP and HTTPS requests. The second resource record, displayed on the second line, is an MX resource record with a priority of “10” showing that e-mail is handled by “mailserver.com”. The third and fourth resource records, shown on the third and fourth lines, are NS records which show that the authoritative name servers for the domain name are “ns1.nameserver.com” and “ns2.nameserver.com”. The final resource record on the fifth line is a TXT record in a Sender Policy Framework (“SPF”) format.

SPF is an established way to tackle spam. SPF allows domain name owners to list servers that are allowed to send e-mail on behalf of the domain name. The SPF record in the example above means that the only IP address allowed to send e-mail on behalf of the domain name “example.com” is the IP address 123.45.67.89. The final part “-all” means that e-mail from all other IP addresses should be treated as spam. Recipient e-mail servers check the SPF record when receiving e-mail from a domain name and follow the guidance in the SPF record to help filter and block spam e-mail.

The DNS is made up of zones, starting with the root zone. Each domain name label does not necessarily represent a different zone. A “child” zone has a parent zone, and that parent zone may have a parent zone itself etc. The term “sub-zone” is sometimes used instead of the term “child zone”. Parent and child zones are split by zone cuts. The parent zone is above the zone cut and the child zone is below the zone cut. Every zone has an origin. The origin of the zone is the domain name just below the zone cut. By way of an example, a simplified zone file for the example domain name “example.com” may be as follows, where text starting with the symbol # indicates an explanatory comment:

@ A 64.233.165.100 # “@” represents the origin, in this example
example.com
www A 64.233.165.100 # This record is for www.example.com
txtrecord1 TXT “Information 1” # This record is for
txtrecord1.example.com
txtrecord2 TXT “Information 2” # This record is for
txtrecord2.example.com
a.b.c TXT “Information 3” # This record is for a.b.c.example.com

As explained above, each of the lines in the example zone file above represents a resource record. As also indicated above, each resource record has a label, class, type, TTL and data, though only some of these are shown in the example zone file above. Although the term “label” is the same as that used in relation to domain names, a label of a resource record (which is sometimes referred to herein as a “resource record label”) is different from a domain name label. For example, a resource record label can contain multiple domain name labels. Resource record labels are prepended (also known as “prefixed”) to the origin of a zone to make a domain name Using the above example zone file for the domain name “example.com”, if the origin of a zone is “example.com” the resource record with the resource record label “a.b.c” will be returned for queries for the domain name “a.b.c.example.com”.

As indicated above, a zone may be split by one or more zone cuts. The following example zone file for the domain name “example.com” has no zone cuts:

| | | | | |
|---|---|---|---|---|
| @ | | | A | 64.233.165.100 |
| WWW | | A | | 64.233.165.100 |
| txtrecord1 | TXT | | “Information | 1” |
| txtrecord2 | TXT | | “Information | 2” |
| a.b.c TXT “Information 3” | | | | |

In the domain “example.com”, the zone cuts are at “com” and “example”. There are separate zone files for both “com” and “example.com”. However, there are no zone cuts at “txtrecord1”, “txtrecord2” or “a.b.c” in the above example. “txtrecord1”, “txtrecord2” and “a.b.c” are resource record labels of resource records within the “example.com” zone file.

The following example zone file for the domain name “example.com” does, however, have zone cuts because the zone file delegates part of the “example.com” zone, namely the child zones “txtrecord1.example.com” and “txtrecord2.example.com” to the name server “ns.txtrecords.com”:

| | | |
|---|---|---|
| @ | | A 64.233.165.100 |
| WWW | A | 64.233.165.100 |
| txtrecord1 | | NS ns.txtrecords.com |
| txtrecord2 | NS | ns.txtrecords.com |
| a.b.c TXT “Information 3” | | |

In the above example, “a.b.c” has not been delegated. The example zone file above with zone cuts points to another name server using the NS resource record type to indicate that the other name server answers queries for the domain names “txtrecord1.example.com” and “txtrecord2.example.com”. Such a name server does not have to exist and the zones “txtrecord1.example.com” and “txtrecord2.example.com” do not have to exist on the other name server. However, if they do not exist, a DNS TXT query for either of these domain names will fail. For DNS TXT queries for the domain name “txtrecord1.example.com” to succeed, the name server at “ns.txtrecords.com” has the following resource record in its zone file for the domain name “txtrecord1.example.com”:
@ TXT “Information 1”

For DNS TXT queries for the domain name “txtrecord2.example.com” to succeed, the name server at “ns.txtrecords.com” also has the following resource record in its zone file for the domain name “txtrecord2.example.com”:
@ TXT “Information 2”

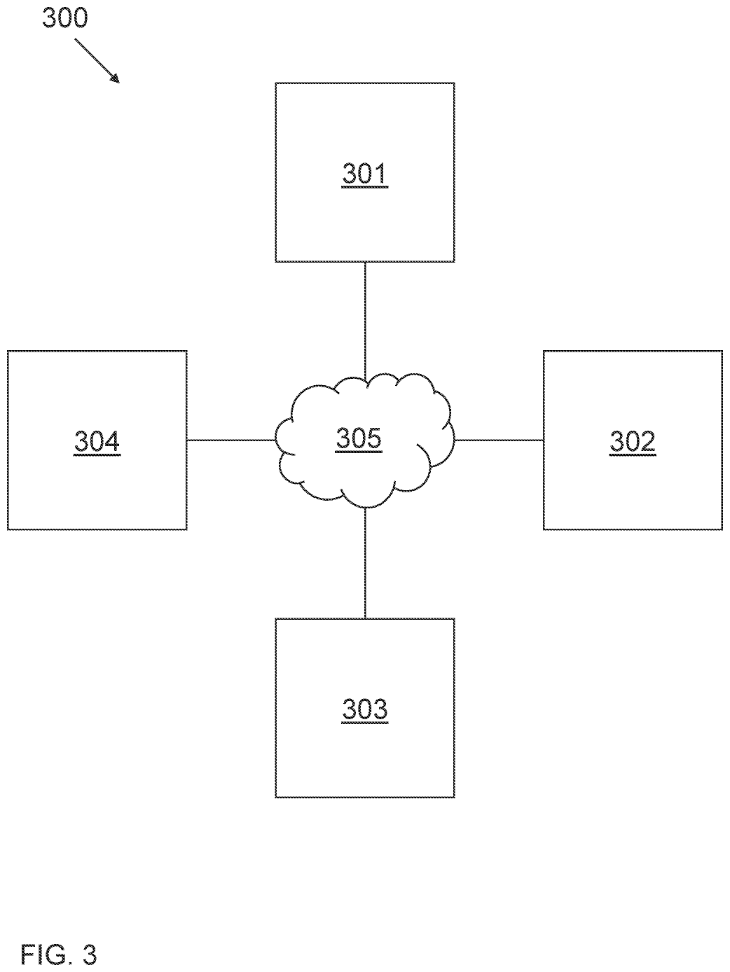

Referring to FIG. 3, there is shown schematically a block diagram of an example of a data communications network 300. The data communications network 300 may be used to process data in the manner described in detail herein.

In this example, the data communications network 300 comprises a first apparatus 301, a second apparatus 302, a third apparatus 303 and a fourth apparatus 304. In this example, the four apparatuses 301, 302, 303, 304 are interconnected via a network 305. In this example, the network 305 comprises a computer network. In this example, the computer network 305 is the Internet. In this example, the first apparatus 301 comprises a user device. In this example, the second apparatus 302 comprises a first name server. In this example, the third apparatus 303 comprises a second name server. In this example, the fourth apparatus 304 comprises a third name server. The techniques described herein may, however, be implemented in a data communications network having a different configuration from that of the example data communications network 300.

As explained above, information (such as contact information) associated with a domain name may be stored in a resource record in a zone file. However, storing information associated with significant numbers of domain names in significant numbers of resource records in a single zone file may not be practical or even possible. This may be because of zone file management and/or resource record limit considerations, or otherwise.

Instead of storing all such information in a single zone file for a single zone, a zone cut may be performed and a number of child zones may be created for storage of such information, with each child zone having its own zone file. The number of resource records that may be stored may thereby be increased by a factor dependent on the number of child zones created. For example, twenty-six child zones may be created, with the left-most label of the domain name for each child zone corresponding to a Latin letter (“a” to “z”). Example child zones of the example parent zone “lookup.nomserver.com” may therefore be “a.lookup.nomserver.com”, “b.lookup.nomserver.com” and so on through “z.lookup.nomserver.com”. Information associated with a domain name may be stored in a resource record in a zone file for the child zone whose left-most label corresponds to the first character of the domain name. For example, information associated with the domain name “example.com” may be stored in a resource record in the zone file for the child zone “e.lookup.nomserver.com” (the first character of the domain name “example.com”, namely the character “e”, corresponds to the left-most label of the domain name “e.lookup.nomserver.com”, namely “e”), information associated with the domain name “anotherexample.com” may be stored in a resource record in the zone file for the child zone “a.lookup.nomserver.com”, etc. Where the first character of a domain name is not a Latin letter, information associated with the domain name may be stored in a resource record in a zone file for the child zone whose left-most label corresponds to a predetermined Latin letter. The predetermined Latin letter may, for example, be “z”. For example, information associated with the domain name “1example.com” may be stored in a resource record in the zone file for the child zone “z.lookup.nomserver.com” etc. A querying device (for example the user device 301) requesting information associated with the domain name “example.com” may be configured to construct the domain name “example.com.e.lookup.nomserver.com” by suffixing the first character of the domain name “example.com”, namely the letter “e”, to the domain name “example.com”, and prefixing the result to the domain name “lookup.nomserver.com”. The resulting domain name would be “example.com.e.lookup.nomserver.com”. The querying device may then transmit a domain name system query for the domain name “example.com.e.lookup.nomserver.com”, instead of a domain name system query for the domain name “example.com”. This may result in a resource record having the resource record label “example.com” being obtained from the zone file for the domain name “e.lookup.nomserver.com”. In this way, twenty-six times more resource records may be stored. Using the example limitation of 10,000 resource records per zone file, this may allow 260,000 resource records to be stored compared to 10,000 resource records where only a single zone file is used. Further, the resource records are stored in the child zones in a predictable manner. This may be expanded by having an additional ten child zones of the zone “lookup.nomserver.com”, with the left-most character of each additional child zone corresponding to an Arabic numeral (“0” to “9”). For example, instead of information associated with the domain name “1example.com” being stored in a resource record in the zone file for the child zone “z.lookup.nomserver.com”, such information may be stored in a resource record in the zone file for the child zone “Elookup.nomserver.com”, etc. In this way, a further 100,000 resource records may be stored such that 360,000 resource records may be stored across the thirty-six child zones (from “a.lookup.nomserver.com” to “9.lookup.nomserver.com”). While this may greatly expand the number of resource records available compared to using a single zone file and may provide sufficient resource records for some purposes, other applications may involve more resource records. In particular, only twenty-six (for “a” to “z” only) or thirty-six (for “a” to “z” and “0” to “9”) child zones may be created using these techniques.

These techniques may be expanded further to enable more child zones of the “lookup.nomserver.com” zone to be created, and hence more resource records to be available. Instead of the left-most label of each child zone of the “lookup.nomserver.com” zone corresponding to one Latin letter or one Arabic numeral, the left-most label of each child zone may correspond to two Latin letters, two Arabic numerals or one Latin letter and one Arabic numeral. Information associated with a given domain name may be stored in a resource record in a zone file for the child zone whose left-most label corresponds to the first two characters of the domain name. For example, child zones “aa.lookup.nomserver.com”, “ab.lookup.nomserver.com” through to “99.lookup.nomserver.com” may be created. Information associated with the domain name “example.com” may be stored in a resource record in the zone file for the child zone whose left-most label corresponds to the first two characters of the domain name “example.com”, namely the “ex.lookup.nomserver.com” child zone. Such a resource record may have the resource record label “example.com”. Similarly, information associated with the domain name “anotherexample.com” may be stored in a resource record in the zone file for the child zone “an.lookup.nomserver.com” etc. This results in more child zones than where a single character is used for the left-most label of the child zone. This mechanism may be extended further such that information associated with a given domain name is stored in a resource record in a zone file for the child zone whose left-most label corresponds to the first three, four, five etc characters of the domain name. While this may enable a significant number of resource records to be stored, it may result in a relatively large number of resource records for domains names beginning with common characters (for example in the “a . . . ”, “e . . . ” etc. child zones) and a relatively small number of resource records for domains names beginning with uncommon characters (for example in the “z . . . ”, “7 . . . ” etc. child zones). This may result in an uneven distribution of resource records across the child zones. This, in turn, may result in some of the zone files reaching the resource record limit well ahead of other zone files.

In addition, such mechanisms involve setting up a significant number of child zones ahead of resource records being stored. This may result in inefficient use of resources, for example where some of the child zones are used infrequently or are not used at all. There may be a tendency to over-estimate the amount of resource records that will be used to reduce the likelihood of the resource record limit being reached. Such mechanisms may also not handle situations effectively in which the resource record limit is reached.

Examples described herein distribute (also referred to herein as “spread”) domain names more evenly across child zones using a domain name distribution operation. This provides a degree of load-balancing, particularly, but not exclusively, where the domain name distribution results in distribution of load to an increased number of name servers. An “operation” may be implemented in various different ways. For example, an “operation” may correspond programmatically to a function performed on input data to generate output data. As such, each child zone may have roughly equal numbers of resource records and all child zones are likely to approach the resource record limit at similar times. Further, new child zones can be created on-demand, for example when a parent child zone has reached its resource record limit.

Examples involve use of a domain name associated with a zone. In examples, the domain name is “lookup.nomserver.com” and the zone is the “lookup.nomserver.com” zone. However, this is by way of example only and other domain names and zones may be used. In response to a trigger event, a zone cut is performed. A number of child zones are created under the “lookup.nomserver.com” parent zone. In examples, thirty-six child zones are created with associated domain names “a.lookup.nomserver.com” through “9.lookup.nomserver.com”. However, a different number of child zones may be created in other examples. In response to a further trigger event, a new set of child zones is created. Such further trigger event may be associated with the resource record limit of one of the initial thirty-six child zones being reached. Such an event may correspond to the resource record limit actually being reached or may correspond to the resource record count being a predetermined number below the resource record limit. The latter may enable the zone cut to be performed in anticipation of the resource record limit being reached. In examples, thirty-six new child zones are created for each of the existing thirty-six child zones, resulting in 1,296 zones. A different number of child zones may be created, however. In addition, instead of creating thirty-six new child zones for each of the existing thirty-six child zones at the same time, in some examples, thirty-six new child zones are created for a particular existing child zone when the resource record limit of that existing child zone is reached or is anticipated to be reached. As and when the resource record limit of other existing child zones is reached or is anticipated to be reached, thirty-six new child zones are created for that existing child zone. This provides finer control over resource usage. Assuming each zone has a limit of 10,000 resource records, up to 12,960,000 resource records can be stored across the 1,296 zones. The 1,296 zones may have associated domain names “a.a.lookup.nomserver.com”, “a.b.lookup.nomserver.com” through “9.9.lookup.nomserver.com”. A further set of child zones may again be created. For example, a further thirty-six child zones can be created for each of the existing 1,296 zones, resulting in 46,656 zones (from “a.a.a.lookup.nomserver.com” through “9.9.9.lookup.nomserver.com”) and up to 466,560,000 resource records. This process may be repeated as and when additional capacity is sought.

Further, instead of storing resource records in zones based on the first character(s) of the domain name (as described above), a domain name distribution operation is performed on the domain name and resource records are stored based on the data resulting from the domain name distribution operation. The domain name distribution operation distributes the domain names more evenly across output values. In examples, the domain name distribution operation comprises a hashing operation. The hashing operation may use a hash function, which maps input data to hashed data. As such, in examples, a domain name hashed. A hash function is designed to map input values uniformly across output values. Further, a hash function can take input values of different lengths. Using a hash function can therefore be effective with domain names, which can have different lengths, as inputs. In addition, a hash function can provide privacy in relation to the input data, which may be especially effective where the domain name system is a public system. One or more characters from the hashed data (the result of hashing the domain name) are used to determine the zone in which a resource record for a given domain name is stored.

Although, in examples, hash functions are used, other operations for distributing domain names may be used. For example, uneven domain name distribution may be made more even by analysing the frequency of characters in domain names and grouping characters together such that each character group has a roughly equal frequency. For example, a child zone “group1.lookup.nomserver.com” may store information for a first group of domain names having an approximately equal likelihood of being queried as a second group of domain names, which can be stored at “group2.lookup.nomserver.com”. The grouping may be based on the first character of the domain name, for example. For example, domain names having the first letters “e” and “t” (which may be associated with the first group) may have a roughly equal frequency of being queried as domain names having the first letters “a”, “o” and “i” (which may be associated with the second group). A querying device may be configured, for example, to construct a domain name of “example.com.group1.lookup.nomserver.com” to obtain information for the domain name “example.com”, to construct a domain name of “anotherexample.com.group2.lookup.nomserver.com” to obtain information for the domain name “anotherexample.com”, etc. The querying device may, for example, store a table mapping characters to corresponding groups. Such a domain name distribution operation may, however, reduce the number of groups and hence resource records that can be used since multiple letters are grouped together. This can also result in relatively complex mappings of domain name characters onto child zones and the querying device having to store such mappings.

In examples, a querying device (for example the user device 301) is configured to construct domain name system queries for a domain name of interest such that a responding device (for example a name server) can readily identify the correct zone and corresponding resource record. In addition, in examples, the querying device can perform the same domain name system query before and after the zone cuts described above have been performed. As such, the creation of additional child zones is, in effect, transparent to the querying device.

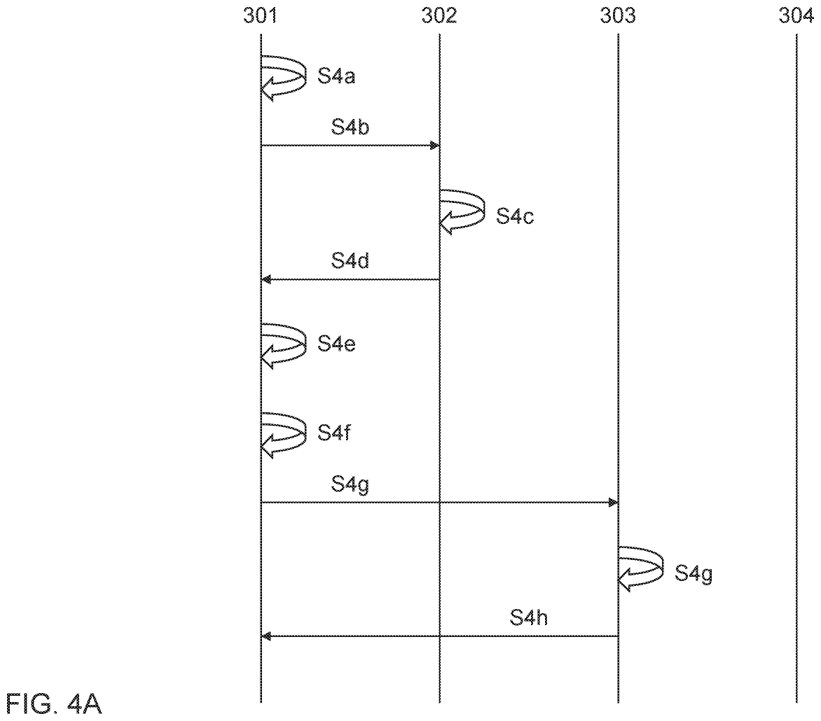

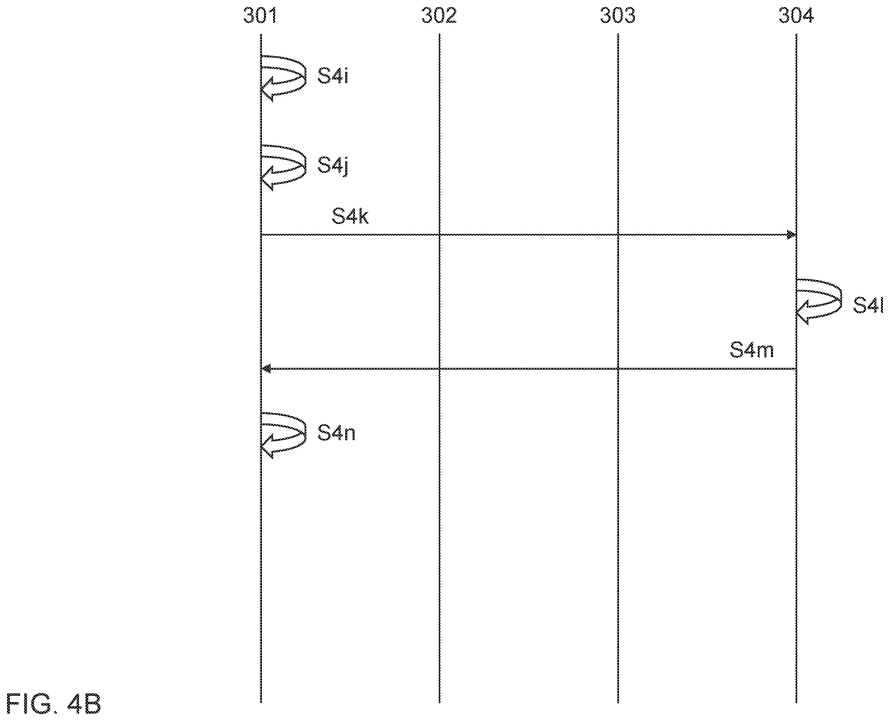

Referring to FIG. 4, there is shown an example of a method 400 of processing data in a hierarchical domain name system. In this example, the domain name system comprises the DNS. In this example, the method 400 enables data processing to be performed in the example data communications network 300 described above with reference to FIG. 3.

In this example, it is assumed that a zone cut has already been performed in relation to the “lookup.nomserver.com” zone, such that there are thirty-six child zones of the “lookup.nomserver.com” zone, with associated domain names “a.lookup.nomserver.com” through “9.lookup.nomserver.com”. In this example, an authoritative name server for “lookup.nomserver.com” zone has delegated responsibility for the child zones to respective name servers. This provides a degree of load balancing in that multiple name servers are now responsible for the resource records for which one name server was responsible prior to the zone cut. In examples, the child zone in which a resource record associated with a given domain name is stored is determined by, first, performing a hashing operation on the given domain name In this example the given domain name is “example.com” and the hashing uses the SHA-1 cryptographic hash function. Non-cryptographic hash functions may be used in other examples. Other types of cryptographic hash function, such as SHA-2, SHA-3, MD5 etc, may be used in other examples. Hashing the domain name “example.com” using SHA-1 results in the hashed data “0caaf24ab1a0c33440c06afe99df986365b0781f”. The hashed data is in base 16. As such, each character of the hashed data is restricted to being a number from “0” to “9” inclusive, or a letter from “a” to “f” inclusive. Letters from “g” to “z” are not permitted. Base 16 data may be referred to as “base16”, “base-16-encoded”, “hexadecimal” data. The term “radix” is sometimes used in this context instead of the term “base”. One or more characters from the hashed data may be used to identify the correct zone for the domain name “example.com”. For example, the first character, namely “0”, of the hashed data may be used such that information associated with the domain name “example.com” is stored in a zone file for the domain name “0.lookup.nomserver.com”. However, this would result in a large number of the child zones, from “g.lookup.nomserver.com” to “z.lookup.nomserver.com”, not being used. While such child zones may, intentionally, not be created, doing so would reduce the number of zones and hence resource records available. As such, in examples, the hashed data is processed using a base conversion operation. In examples, the base conversion operation increases the base of the hashed data. In this example, the base conversion operation increases the base of the hashed data from sixteen to thirty-six. However, different bases may be used in other examples. Base 36 is particularly, but not exclusively, effective when working with domain name labels. Domain names can only include characters 0-9, a-z, the underscore (_) and hyphen (-). Domain names are case insensitive. Domains registered through Registries (e.g. example.com) cannot include the underscore and cannot start or end with a hyphen. Many implementations of DNS prevent labels containing only a hyphen or an underscore, although both are technically valid DNS names, because they are not valid hostnames for websites. As such, although both the hyphen and underscore characters are allowed in DNS names and both are allowed to be a label in their own right, in practice some clients, resolvers and servers cannot run queries where a label is solely an underscore or label, e.g. “-.example.com” or “_.example.com”. Base 36 therefore enables all characters (in base 36) to be used as labels. Base 36 uses thirty-six characters (“a” to “z” and “0” to “9”), which equals the number of child zones of the “lookup.nomserver.com” zone. Further, each of the thirty-six characters (“a” to “z” and “0” to “9”) corresponds to the left-most label of one of the child zones. Base 36 data may be referred to as “base36”, “base-36-encoded” or “hexatridecimal” data. Converting the hashed data from base 16 to base 36 results in base-converted data of “1h9qjmui5mtlhp97qz4przu5dwsd25b”. In this example, the base-converted data is processed using a character selection operation. The character selection operation selects a predetermined number of characters of the base-converted data. The predetermined number may be one or may be greater than one. Such selection may be performed in various ways. For example, characters may be extracted from the base-converted data, the base-converted data may be truncated such that the remaining characters are selected etc. In this example, the character selection operation truncates the base-converted data such that only the first four characters, namely “1”, “h”, “9” and “q”, remain and are selected. A different number of characters may be selected and/or the selected characters may not be the first characters in other examples. For example, the final four characters may be selected in other examples. As will be seen from the below, selecting a relatively small number of characters at this stage, results in shorter domain names being constructed as fewer characters are used. However, fewer characters results in fewer zones and hence fewer resource records. Using larger numbers of characters can enable more resource records to be available, but with longer domain names. The number of characters may be selected to trade off these considerations. Four, five, or six characters may represent such a trade off in the scenarios described herein. In some examples, a further domain name is constructed by prepending the four extracted characters of the base-converted data (namely “1”, “h”, “9” and “q”), to the domain name “lookup.nomserver.com” as a single label, and appending the result to the domain name “example.com”. In such an example, the resulting domain name would be “example.com.1h9q.lookup.nomserver.com”. This would provide a more even distribution across domain names, for example ±10% across all zones, and would create 36\hat{ }4=1,679,616 child zones in which resource records could be stored. However, similar to examples described above, the child zones would be created in advance and not on-demand In other examples, the further domain name is constructed by prepending the four extracted characters of the base-converted data (namely “1”, “h”, “9” and “q”), to the domain name “lookup.nomserver.com” but separated by dots, and appending the result to the domain name “example.com”. In such an example, the resulting domain name would be “example.com.1.h.9.q.lookup.nomserver.com”. This enables child zones to be created on-demand, as will be explained in more detail below. In this example, the right-most of the four labels (i.e. the fourth of the four labels), namely “q”, determines in which child zone the resource record associated with the domain name “example.com” is initially stored. In this example, the left-most label of the child zone corresponds to the right-most label “q”, such that the child zone in which the information associated with the domain name “example.com” is initially stored is the “q.lookup.nomserver.com” child zone. If a new set of child zones were created under the existing thirty-six zones, then the right-most two of the four labels above (i.e. the third and fourth labels), namely “9” and “q”, may be used to determine in which child zone the resource record associated with the domain name “example.com” is stored. In particular, in accordance with examples, such a resource record may be stored in the child zone associated with the domain name “9.q.lookup.nomserver.com”. If a further thirty-six child zones were created, then the resource record associated with the domain name “example.com” may be stored in the child zone associated with the domain name “h.9.q.lookup.nomserver.com” and so on. Resource records may be moved from a parent zone to a child zone by delegating responsibility for the child zone to a different name server and relabelling the resource record. For example, a TXT resource record associated with the domain name “example.com” may initially be stored in the zone file for the domain name “q.lookup.nomserver.com” as:
example.com.1.h.9 TXT “INFORMATION FOR EXAMPLE.COM”

Such a resource record has the resource record label “example.com.1.h.9”. A domain name system request for the domain name “example.com.1.h.9.q.lookup.nomserver.com” would return the above resource record. The information associated with the domain name “example.com” (the third domain name) may take various different forms. In some examples, the information comprises contact information associated with an entity associated with the domain name “example.com” (the third domain name). Such contact information may comprise a telephone number, e-mail address etc. The entity may be an owner of the domain name, a Registrant of the domain name etc. Other types of information associated with the domain name may be used in other examples. Such other information may include, for example, the nature, opening times etc of a business associated with the domain name.

If the “q.lookup.nomserver.com” were split to have thirty-six child zones, the resource record may be moved to the zone file for the domain name “9.q.lookup.nomserver.com” and have the following form:
example.com.1.h TXT “INFORMATION FOR EXAMPLE.COM”

Such a resource record has the resource record label “example.com.1.h”. A domain name system request for the domain name “example.com.1.h.9.q.lookup.nomserver.com” would return the above resource record.

Returning now to FIG. 4, at item S4a, the user device 301 obtains the domain name “example.com”. This domain name is sometimes referred to herein as the “third domain name”. The user device 301 can obtain the third domain name in various different ways. For example, a user of the user device 301 may input the third domain name, the user device 301 may obtain the third domain name from memory, from a remote source etc. The user device 301 is configured to construct a modified domain name (sometimes referred to herein as the “first domain name”), on the basis of which a domain name system query is performed. This involves processing the domain name using a domain name modification operation. In examples, the input to the domain name modification operation comprises a domain name, and the output of the domain name modification operation is different from the input. The output of the domain name modification operation may or may not comprise a domain name. In this example, the domain name modification operation comprises a domain name distribution operation, as described above. Other examples of domain name modification operation will however be described. In this example, and as described above, the user device 301 performs the domain name modification operation by hashing the third domain name “example.com” using SHA-1, converting the resulting hashed data from base 16 to base 36, and truncating the resulting base-converted data such that only the first four characters of the base-converted data are selected. The user device 301 has thereby modified the third domain name “example.com”, with the resulting modified data being “1h9q”. The result of the domain name modification is therefore not necessarily a domain name. The user device 301 constructs the first domain name by prepending the selected first four characters (namely, “1”, “h”, “9” and “q”) to the domain name “example.com”, and appending the result to the domain name “lookup.nomserver.com” (sometimes referred to herein as the “second domain name”). The first domain name, which results from the above construction, is “example.com.1.h.9.q.lookup.nomserver.com”. In this example, the resulting domain name “example.com.1.h.9.q.lookup.nomserver.com” (the first domain name) includes the domain name “example.com” (the third domain name), the domain name “lookup.nomserver.com” (the second domain name) and multiple domain name labels (namely, “1”, “h”, “9” and “q”) therebetween. As such, in this example, the domain name labels follow the third domain name in the first domain name. The domain name labels in this example have been obtained based on the domain name “example.com” (the third domain name) having been processed using a domain name modification operation. In this example, the domain name modification operation comprises a hashing operation, a base conversion operation and a character selection operation. In this example, the domain name “example.com” (the third domain name) is a resolvable domain name Information associated with the domain name “example.com” (the third domain name) could, and may be, stored in a zone file for the domain name “example.com” (the third domain name). However, the techniques described herein enable additional information to be stored in another domain.

At item S4b, the user device 301 transmits, via the network 305, a domain name system query for “example.com.1.h.9.q.lookup.nomserver.com” (the first domain name) The domain name system query of item S4b reaches the authoritative name server for the domain name “q.lookup.nomserver.com”. In this example, the first name server 302 is the authoritative name server for the domain name “q.lookup.nomserver.com”. In this example, the zone file for the domain name “q.lookup.nomserver.com” comprises the following resource record having the resource record label “example.com.1.h.9”:
example.com.1.h.9 TXT “INFORMATION FOR EXAMPLE.COM”

At item S4c, the first name server 302 processes the received domain name system query for the domain name “example.com. 1.h.9.q.lookup.nomserver.com” (the first domain name). In this example, such processing comprises obtaining the resource record with the resource record label “example.com.1.h.9”.

At item S4d, the first name server 302 transmits, via the network 305, a response to the domain name system query for the domain name “example.com.1.h.9.q.lookup.nomserver.com” (the first domain name). The response of item S4d comprises the resource record with the resource record label “example.com.1.h.9”, which includes the information “INFORMATION FOR EXAMPLE.COM”. In some examples, the response of item S4d comprises multiple resource records, for example, where information associated with the domain name “example.com” (the third domain name) is split over multiple resource records.

The user device 301 receives, via the network 305, the response of item S4d.

At item S4e, the user device 301 processes the response of item S4c. Such processing comprises identifying the information associated with the domain name “example.com” (the third domain name) in the resource record with the resource record label “example.com.1.h.9”. In this example, such processing involves extracting the information “INFORMATION FOR EXAMPLE.COM” from the resource record. The extracted information may be used in various different ways. For example, the extracted information may be displayed to a user of the user device 301.

As such, in this example, the domain name “lookup.nomserver.com” (the second domain name) corresponds to a parent zone. The “lookup.nomserver.com” parent zone has a plurality of child zones, in this example thirty-six child zones. The resource record comprising the information associated with the domain name “example.com” (the third domain name) is obtained from a zone file for one of the thirty-six child zones, in this example, the zone file for the “q.lookup.nomserver.com” child zone. The particular child zone, namely the “q.lookup.nomserver.com” child zone, in which the information associated with the domain name “example.com” (the third domain name) is stored is identified based on the at least one domain name label, namely “1”, “h”, “9” and “q”. At this stage, the particular child zone is identified based on the right-most one of the multiple domain name labels, namely “q”. In this example, the left-most label of the “q.lookup.nomserver.com” child zone, namely “q”, corresponds to the right-most of the multiple domain name labels, namely “q”.

Further, a domain name (“example.com”) has been obtained. The obtained domain name (“example.com”) has been hashed to generate hashed data (“0caaf24ab1a0c33440c06afe99df986365b0781f”) in a first base (base 16 in this example). The obtained hashed data in the first base is converted to a second, higher base (base 36 in this example) to generate base-converted data (“1h9qjmui5mtlhp97qz4przu5dwsd25b”) in the second, higher base. One or more characters of the base-converted data in the second, higher base are selected (in this example, the first four characters “1”, “h”, “9” and “q” are selected). A domain name system query comprising at least the selected one or more characters is transmitted. In response to the transmitted domain name system request, a response is received. The response comprises information associated with the domain name (“example.com”).

At item S4f, the user device 301 obtains a further domain name In this example, the further domain name is “anotherexample.com”. Similarly to item S4a, the user device 301 first hashes the further domain name “anotherexample.com” using SHA-1, to obtain the hashed data “e17ee60e98b6a9aef2154831b8f843a63820e1f9”. The user device 301 converts the data in base 16 to data in base 36, which results in the base-converted data of “qc96ayj8q2s3mb8nr3hk392pjqzqdix”. The user device 301 extracts the first four characters of the base-converted data, namely “q”, “c”, “9” and “6”, prepends the four extracted characters, separated by dots, to the domain name “lookup.nomserver.com” (the second domain name), and appends the result to the domain name “anotherexample.com” (the further domain name). The resulting domain name is “anotherexample.com.q.c.9.6.lookup.nomserver.com”.

At item S4g, the user device 301 transmits, via the network 305, a domain name system query for the domain name “anotherexample.com.q.c.9.6.lookup.nomserver.com”. In this example, the child zone “6.lookup.nomserver.com” has been delegated to the second name server 303. The domain name system query of item S4g therefore reaches the second name server 303. In this example, the zone file for the domain name “6.lookup.nomserver.com” comprises the following TXT resource record having resource record label “anotherexample.com.q.c.9”:
anotherexample.com.q.c.9TXT “INFORMATION FOR ANOTHEREXAMPLE.COM”

Items S4h and S4i correspond generally to items S4d and S4e respectively.

An event occurs, which results in each of the thirty-six child zones being split into a further thirty-six child zones.

In this example, the first name server 302 has delegated responsibility for the further child zone “9.q.lookup.nomserver.com” to the third name server 304. For example, the zone file for the domain name “q.lookup.nomserver.com” (for which the first name server 302 is still the authoritative name server in this example) comprises the following NS resource record having the resource record label “9”:
9 NS <<DOMAIN-NAME-NAMESERVER304>>

“DOMAIN-NAME-NAMESERVER304” represents the domain name of third name server 304 in the example resource record above. In addition, the resource record comprising information associated with the domain name “example.com” (the third domain name) has been moved from the zone file for the domain name “q.lookup.nomserver.com” to the zone file for the domain name “9.q.lookup.nomserver.com”. In this example, the zone file for the domain name “9.q.lookup.nomserver.com” comprises the following TXT resource record having the resource record label “example.com.1.h”:
example.com.1.h TXT “INFORMATION FOR EXAMPLE.COM”

Item S4j corresponds to item S4a in that the user device 301 constructs a domain name system query for the domain name “example.com.1.h.9.q.lookup.nomserver.com” (the first domain name). The user device 301 may be unaware of the changes described above.

Items S4k to items S4n correspond generally to items S4b to S4e respectively, except that the domain name system query of item S4k ultimately reaches, and is handled by, the third name server 304 instead of the first name server 302.

As such, at this stage, the domain name “q.lookup.nomserver.com” corresponds to a parent zone. The “q.lookup.nomserver.com” parent zone has a plurality of child zones, in this example thirty-six child zones. The resource record comprising the information associated with the domain name “example.com” (the third domain name) is obtained from a zone file for one of the thirty-six child zones, in this example, the zone file for the “9.q.lookup.nomserver.com” child zone of the “q.lookup.nomserver.com” parent zone. The particular child zone, namely the “9.q.lookup.nomserver.com” child zone, in which the information associated with the domain name “example.com” (the third domain name) is stored is identified based on the at least one domain name label, namely “1”, “h”, “9” and “q”. At this stage, the particular child zone is identified based on the right-most two of the multiple domain name labels, namely “9” and “q”. In this example, the left-most label of the “9.q.lookup.nomserver.com” child zone, namely “9”, corresponds to the second right-most of the multiple domain name labels, namely “9”.

Further, in this example, a plurality of child zones (“a.lookup.nomserver.com” through “9.lookup.nomserver.com”) of a parent zone (“lookup.nomserver.com”) have been caused to be created. As explained above, child zones can be created on-demand in different ways, such as creating child zones of all existing zones at the same time, or creating child zones for zones that reach capacity. Information associated with a given domain name (in this example, the domain name “example.com”) has been caused to be stored in a zone file for one of the plurality of child zones, namely the “q.lookup.nomserver.com” child zone. A left-most label of the one of the plurality of child zones, namely the label “q”, comprises data derived based on the given domain name (“example.com”) having been processed using a domain name distribution operation. In this example, the domain name distribution operation comprises a hashing operation, a base conversion operation and a character selection operation. For each of the plurality of child zones (“a.lookup.nomserver.com” through “9.lookup.nomserver.com”), a plurality of further child zones has been caused to be created (“a.a.lookup.nomserver.com” through “9.9.lookup.nomserver.com”). The information associated with the given domain name (“example.com”) has been caused to be stored in a zone file for one of the plurality of further child zones, namely the “9.q.lookup.nomserver.com” further child zone. A left-most label of the one of the plurality of further child zones, namely the label “9”, comprises data derived based on the given domain name having been processed using the domain name distribution operation.

In examples described above, the first domain name comprises the third domain name. For example, the example first domain name “example.com.1.h.9.q.lookup.nomserver.com” comprises the example third domain name “example.com”. In other examples, the first domain name does not comprise the third domain name. For example, instead of comprising the example third domain name “example.com”, the first domain name may comprise the hash of the third domain name. For example, the first domain name may be “0caaf24ab1a0c33440c06afe99df986365b0781f.1.h.9.q.lookup.nomserver.com” and the information associated with the domain name “example.com” may be stored in a resource record having the resource record label “0caaf24ab1a0c33440c06afe99df986365b0781f” in the zone file for the domain name “1.h.9.q.lookup.nomserver.com”. In another example, the first domain name may comprise the base-converted data. For, example the information associated with the domain name “example.com” may be stored in a resource record having the resource record label “1h9qjmui5mtlhp97qz4przu5dwsd25b” in the zone file for the domain name “1.h.9.q.lookup.nomserver.com”. In other examples, neither the third domain name nor data derived from the third domain name is included in the first domain name

In examples described above, the labels, namely “1”, “h”, “9” and “q”, in the first domain name each consist of a single character. In examples, some or all of the labels comprise multiple characters. For example, the first domain name may be formulated as “example.com.1h9.q.lookup.nomserver.com”, which includes a mix of single-character and multiple-character domain name labels.

In examples described above, the user device 301 always extracts the same number of characters from the base-converted data. In other examples, the number of characters may be varied dynamically. For example, the user device 301 might initially construct the first domain name as “example.com.q.lookup.nomserver.com” using the fourth character of the base-converted data. In response to a trigger, the user device 301 might construct the first domain name as “example.com.9.q.lookup.nomserver.com” using the third and fourth characters of the base-converted data. The trigger may comprise a software update. While this may facilitate reducing the length of the first domain name in line with the number of child zones, there is a risk of domain name system queries being incorrectly constructed until the software has been updated.

In examples described above, the hashed data is converted into a different base, for example from base 16 to base 36. In other examples, the hashed data is used without such base conversion. Further, although in examples described above the base-converted data is truncated, in other examples, the base-converted data (or hashed data as the case may be) is not truncated.

In examples described above, the domain name modification operation involves a domain name distribution operation. Other types of domain name modification operation are envisaged. For example, the domain name modification operation may involve encrypting or scrambling a domain name or modifying the domain name in any other way. This can enhance privacy as described above and may still enable information associated with the domain name to be stored in a predictable manner.

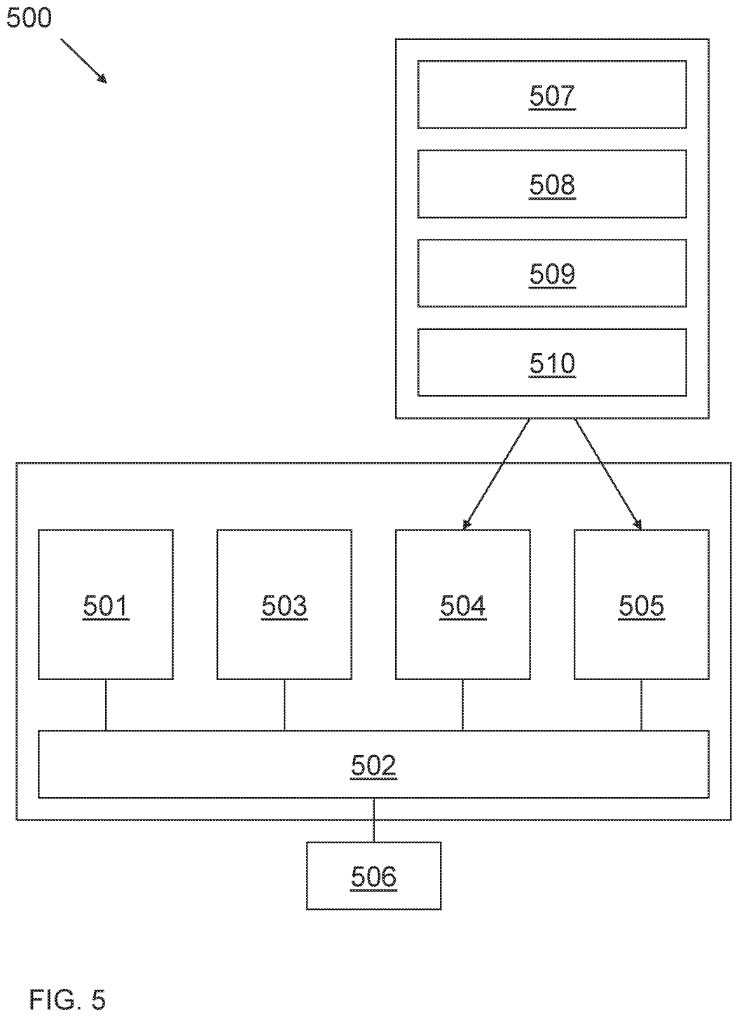

Referring to FIG. 5, there is shown a block diagram of an apparatus 500. The apparatus is configured to process data. The apparatus 500 may, for example, comprise one or more of the apparatuses 301, 302, 303, 304 described above with reference to FIG. 3.

The apparatus 500 may take various different forms. Examples of forms of the apparatus 500 include, but are not limited to, mobile telephony device, a satellite navigation system, a smart television set, a desktop computer, a laptop computer, a server, a name server, a tablet computing device, a router etc.

In this example, the apparatus 500 comprises one or more processors 501 configured to process information and/or instructions. The one or more processors 501 may comprise a central processing unit (CPU). The one or more processors 501 are coupled with a bus 502. Operations performed by the one or more processors 501 may be carried out by hardware and/or software.

In this example, the apparatus 500 comprises computer-useable volatile memory 503 configured to store information and/or instructions for the one or more processors 501. The computer-useable volatile memory 503 is coupled with the bus 502. The computer-useable volatile memory 503 may comprise random access memory (RAM).

In this example, the apparatus 500 comprises computer-useable non-volatile memory 504 configured to store information and/or instructions for the one or more processors 501. The computer-useable non-volatile memory 504 is coupled with the bus 502. The computer-useable non-volatile memory 504 may comprise read-only memory (ROM).

In this example, the apparatus 500 comprises one or more data-storage units 505 configured to store information and/or instructions. The one or more data-storage units 505 are coupled with the bus 502. The one or more data-storage units 505 may for example comprise a magnetic or optical disk and disk drive.

In this example, the apparatus 500 comprises one or more input/output (I/O) devices 506 configured to communicate information to the one or more processors 501. The one or more I/O devices 506 are coupled with the bus 502. The one or more I/O devices 506 may comprise at least one network interface. The at least one network interface may enable the apparatus 500 to communicate via one or more data communications networks. Examples of data communications networks include, but are not limited to, the Internet, a Local Area Network (LAN) and a wide area network (WAN). The one or more I/O devices 506 may enable a user to provide input to the apparatus 500 via one or more input devices (not shown). Examples of input devices include, but are not limited to, a keyboard and a mouse. The one or more I/O devices 506 may enable information to be provided to a user via one or more output devices (not shown). Examples of output devices include, but are not limited to, a computer monitor and a display screen.

Various other entities are depicted for the apparatus 500. For example, when present, an operating system 507, a data processing system 508, one or more modules 509, and data 510 are shown as residing in one, or a combination, of the computer-usable volatile memory 503, computer-usable non-volatile memory 504 and the one or more data-storage units 505. The data processing system 508 may be implemented by way of computer program code stored in memory locations within the computer-usable non-volatile memory 504, computer-readable storage media within the one or more data-storage units 505 and/or other tangible computer-readable storage media.

Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program.

It will be appreciated that the apparatus 500 may comprise more, fewer and/or different components from those depicted in FIG. 5.

As such, in examples, a query input (in other words, an input to or for a query) is hashed. In examples, the input is a domain name. The hash (resulting from the hashing of the input) is truncated. A predetermined number of values of the hash remain. In examples, the predetermined number is four, but other predetermined numbers may be used in other examples. In examples, the first four values of the hash remain. In examples, the first four values are split over multiple domain name labels. In examples, the query input and domain name labels are prefixed to a zone. For example, hashing the query input “example.com” gives the SHA-1 hash “0caaf24ab1a0c33440c06afe99df986365b0781f” in base 16 encoding. This corresponds to “1h9qjmui5mtlhp97qz4przu5dwsd25b” in base 36 encoding. Base 36 encoding allows thirty-six characters to be used instead of sixteen. This can enable the number of child zones to be increased from sixteen to thirty-six, resulting in more capacity for resource records. The first four characters, namely “1”, “h”, “9” and “q” are split into labels: 1.h.9.q. A load-balanced domain name system query of “example.com.1.h.9.q.lookup.nomserver.com” is used. Such a domain name can be constructed in various different ways. For example, the labels can be suffixed to the domain name being queried (example.com) as separate labels and the result prefixed to the domain for a given authoritative zone (lookup.nomserver.com). Any part of the hash of the original input may be prefixed to the other domain. Although in this example, the first four characters of the base-converted hash are used, the final four characters may be used, a different number of characters may be used etc in other examples.

Domain names may thereby be evenly distributed. By splitting domain names into separate domain name labels thirty-six zones may be used initially. For example, one zone called “q.lookup.nomserver.com” with the resource record with the information associated with the domain name “example.com” can be served from a resource record in the “q.lookup.nomserver.com” zone with the resource record label “example.com.1.h.9”. When the capacity for thirty-six zones is reached, thirty-six new zones can set up within each existing zone, resulting in 1,296 zones and so on.

Examples described herein provide hashed scaling, which may also be referred to as hash-based scaling. In examples, a first domain name (for example “example.com.0caaf24ab1a0c33440c06afe99df986365b0781f.lookup.nomserver.com”) includes a second domain name (for example, “lookup.nomserver.com”) and a third domain name (for example, “example.com”). In between the second and third domain names are one or more domain name labels corresponding to some or all of a hash derived by a hashing algorithm (for example, SHA-1) performed on the third domain name. In the example domain name “example.com.0caaf24ab1a0c33440c06afe99df986365b0781f.lookup.nomserver.com”, there is one domain name label between the second and third domain names and the domain name label includes the entire hashed data (base 16, not base 36). The hash may be encoded (for example in base 36). The hash may be truncated (for example, such that the first domain name is example.com.0caaf.lookup.nomserver.com). The characters in the hash may be split amongst many labels (for example, such that the first domain name is “example.com.0.c.a.a.f.lookup.nomserver.com”). Such an example still enables a more even distribution of domain names and flexibility in creating new zones on-demand.

Examples described herein enable standard cloud-based DNS to be used to serve out significant numbers, for example billions, of DNS resource records. Cloud-based DNS may be more scalable, may have improved performance, may have improved reliability, may have improved availability etc compared to non-cloud-based DNS. Using a single zone would, in the case of billions of resource records, be much bigger than all the other TLD zones combined. This may be beyond the technical capability of DNS servers and the maximum file size of a zone file. Further, cloud-based DNS may have a limit on the maximum number (for example 10,000) of resource records per zone. Billions of resource records may therefore not be stored in a single zone. Examples described herein not only enable significant numbers of resource records to be stored, but also spread domain names evenly between child zones of a parent zone and create new child zones on-demand. As such, unlimited resource records can be distributed evenly over unlimited zones with the zone count only increasing as and when new child zones are needed.

In examples, the authoritative name server for the third domain name (“example.com”) is different from the authoritative name server for the second domain name (“lookup.nomserver.com”). This can help reduce the load on the authoritative name server for the third domain name (“example.com”) as a result of the processing described herein. For example, the authoritative name server for the third domain name (“example.com”) can continue to handle standard queries for the third domain name (“example.com”) and the authoritative name server for the second domain name (“lookup.nomserver.com”) can handle queries for information associated with the third domain name (“example.com”) as described herein. Such information associated with the third domain name (“example.com”) can therefore be provided on top of standard information in the domain name system with no or limited impact on the authoritative name server for the third domain name (“example.com”). Where the information associated with the third domain name (“example.com”) is stored in a child zone of the “lookup.nomserver.com” zone, an authoritative name server for the child zone can likewise be selected to be different from the authoritative name server for the third domain name (“example.com”).

Various measures (for example, methods, apparatuses, computer programs and computer-readable media) are provided in which data is processed using a hierarchical domain name system, the method comprising. A domain name system query for a first domain name is transmitted via a network. The first domain name comprises a second domain name and at least one domain name label preceding the second domain name. The at least one domain name label comprises data obtained based on a third domain name having been processed using a domain name modification operation. A response to the domain name system query for the first domain name is received via the network. The response comprises one or more resource records comprising information associated with the third domain name. The response to the domain name system query for the first domain name is processed. Said processing of the response comprises identifying the information associated with the third domain name in the one or more resource records.

This can enable significant numbers of records to be distributed over significant numbers of zones with the zone count only increasing as and when needed.

In some examples, the domain name modification operation comprises a hashing operation and the hashing operation is configured to map the third domain name to hashed data. Hashing can facilitate domain name distribution. Hash functions can also provide a degree of privacy and can operate on inputs of varying lengths.

In some examples, the domain name modification operation comprises a character selection operation, and the character selection operation is configured to select at least one character from the hashed data. This can enable optimisation in terms of domain name length and resource record limits.

In some examples, the hashed data is in a first base, the domain name modification operation comprises a base conversion operation, and the domain name modification operation is configured to map the hashed data in the first base to base-converted data in a second, higher base. Such base conversion can increase the number of resource records available.

In some examples, the second base is thirty-six. This can maximise the number of zones available and can readily facilitate identification of a zone in which information associated with the third domain name is stored.

In some examples, the domain name modification operation comprises a character selection operation, and the character selection operation is configured to select at least one character from the base-converted data. This can enable optimisation in terms of domain name length and resource record limits.

In some examples, the first domain name comprises the third domain name. This can facilitate identification of the zone in which the information associated with the third domain name is stored.

In some examples, the at least one domain name label follows the third domain name in the first domain name. This may facilitate structured storage of information associated with domain names and also facilitate identification of the zone in which the information associated with the third domain name is stored.

In some examples, an authoritative name server for the third domain name is different from an authoritative name server for the first domain name and/or an authoritative name server for the second domain name. This can relieve load on the authoritative name server for the third domain name.

In some examples, the third domain name is a resolvable domain name. Although the information associated with the third domain name could be stored in a zone file for the third domain name in such examples, such information can be stored in a different location. This may reduce the risk of inadvertently creating errors in the zone file for the third domain name which could have a significant impact in relation to the third domain name.

In some examples, the at least one domain name label comprises a plurality of domain name labels. This can enable relatively large numbers of resource records to be available, with the ability to scale on-demand.

In some examples, the at least one domain name label comprises one or more domain name labels consisting of a single character. This can enable flexibility in terms of creating child zones.

In some examples, the at least one domain name label comprises one or more domain name labels comprising a plurality of characters. This can facilitate shorter domain names than where domain name labels consisting of a single character, since fewer separating dots may be used.

In some examples, the information associated with the third domain name comprises contact information associated with an entity associated with the third domain name. This can facilitate obtaining of contact information via the domain name system.

In some examples, the domain name system is cloud-based. A cloud-based domain name system may thereby be used to serve out, potentially, billions of records which may be used in accordance with scenarios described herein.

Various measures (for example, methods, apparatuses, computer programs and computer-readable media) are provided in which data is processed using a hierarchical domain name system. A domain name system query for a first domain name is received via a network. The first domain name comprises a second domain name and at least one domain name label preceding the second domain name. The at least one domain name label comprises data obtained based on a third domain name having been processed using a domain name modification operation. The domain name system query for the first domain name is processed. Said processing comprises obtaining one or more resource records comprising information associated with the third domain name A response to the domain name system query for the first domain name is transmitted via the network. The response comprises the one or more resource records comprising the information associated with the third domain name.

This can enable significant numbers of records to be distributed over significant numbers of zones with the zone count only increasing as and when needed.

In some examples, the second domain name corresponds to a parent zone, the parent zone has a plurality of child zones, and the obtaining of the one or more resource records comprises obtaining the one or more resource records from a zone file for one of the plurality of child zones. By creating such a zone cut, more resource records can be stored in the child zones than could be stored in a zone file for the parent zone.

In some examples, the obtaining of the one or more resource records comprises identifying the one of the plurality of child zones based on the at least one domain name label. This can readily facilitate identification of the zone file in which the information associated with the third domain name is stored.

In some examples, a left-most label of the one of the plurality of child zones corresponds to one or more of the at least one domain name labels. This can provide a reliable mechanism for identifying the zone file in which the information associated with the third domain name is stored.

Various measures (for example, methods, apparatuses, computer programs and computer-readable media) are provided in which data is processed using a hierarchical domain name system. A resource record is processed in response to a domain name system query for a first domain name. The processing of the resource record may be performed by an entity that transmits the domain name system query for the first domain name and/or by an entity that receives the domain name system query for the first domain name. The first domain name comprises a second domain name, a third domain name, and at least one domain name label between the second and third domain names. The at least one domain name label comprises data obtained based on the third domain name having been processed using a domain name modification operation. The resource record comprises information associated with the third domain name.

This can enable significant numbers of records to be distributed over significant numbers of zones with the zone count only increasing as and when needed.

Various measures (for example, methods, apparatuses, computer programs and computer-readable media) are provided in which data is processed using a hierarchical domain name system. A plurality of child zones of a parent zone is caused to be created. Information associated with a given domain name is caused to be stored in a zone file for one of the plurality of child zones. A left-most label of the one of the plurality of child zones comprises data derived based on the given domain name having been processed using a domain name distribution operation. For each of the plurality of child zones, a plurality of further child zones is caused to be created. The information associated with the given domain name is caused to be stored in a zone file for one of the plurality of further child zones. A left-most label of the one of the plurality of further child zones comprises data derived based on the given domain name having been processed using the domain name distribution operation.

This can enable significant numbers of records to be distributed over significant numbers of zones with the zone count only increasing as and when needed.

Various measures (for example, methods, apparatuses, computer programs and computer-readable media) are provided in which data is processed using a hierarchical domain name system. A domain name is obtained. The obtained domain name is hashed to generate hashed data in a first base. The obtained hashed data in the first base is converted to a second, higher base to generate base-converted data in the second, higher base. One or more characters of the base-converted data in the second, higher base are selected. A domain name system query comprising at least the selected one or more characters is transmitted. In response to the transmitted domain name system request, a response is received. The response comprises information associated with the domain name.

This can enable significant numbers of records to be distributed over significant numbers of zones with the zone count only increasing as and when needed.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of processing data using a hierarchical domain name system, the method comprising:
transmitting, via a network, a domain name system query for a first domain name, the first domain name comprising a second domain name and at least one domain name label preceding the second domain name, the at least one domain name label comprising data obtained based on a third domain name having been processed using a domain name modification operation;
receiving, via the network, a response to the domain name system query for the first domain name, the response comprising one or more resource records comprising information associated with the third domain name; and
processing the response to the domain name system query for the first domain name, said processing of the response comprising identifying the information associated with the third domain name in the one or more resource records.

2. The method of claim 1, wherein the domain name modification operation comprises a hashing operation and wherein the hashing operation is configured to map the third domain name to hashed data.

3. The method of claim 2, wherein the domain name modification operation comprises a character selection operation, and wherein the character selection operation is configured to select at least one character from the hashed data.

4. The method of claim 2, wherein the hashed data is in a first base, wherein the domain name modification operation comprises a base conversion operation, and wherein the domain name modification operation is configured to map the hashed data in the first base to base-converted data in a second, higher base.

5. The method of claim 4, wherein the second base is thirty-six.

6. The method of claim 4, wherein the domain name modification operation comprises a character selection operation, and wherein the character selection operation is configured to select at least one character from the base-converted data.

7. The method of claim 1, wherein the first domain name comprises the third domain name.

8. The method of claim 7, wherein the at least one domain name label follows the third domain name in the first domain name.

9. The method of claim 1, wherein an authoritative name server for the third domain name is different from an authoritative name server for the first domain name and/or an authoritative name server for the second domain name.

10. The method of claim 1, wherein the third domain name is a resolvable domain name.

11. The method of claim 1, wherein the at least one domain name label comprises a plurality of domain name labels.

12. The method of claim 1, wherein the at least one domain name label comprises one or more domain name labels consisting of a single character.

13. The method of claim 1, wherein the at least one domain name label comprises one or more domain name labels comprising a plurality of characters.

14. The method of claim 1, wherein the information associated with the third domain name comprises contact information associated with an entity associated with the third domain name.

15. The method of claim 1, wherein the domain name system is cloud-based.

16. A method of processing data using a hierarchical domain name system, the method comprising:
receiving, via a network, a domain name system query for a first domain name, the first domain name comprising a second domain name and at least one domain name label preceding the second domain name, the at least one domain name label comprising data obtained based on a third domain name having been processed using a domain name modification operation;
processing the domain name system query for the first domain name, said processing comprising obtaining one or more resource records comprising information associated with the third domain name; and
transmitting, via the network, a response to the domain name system query for the first domain name, the response comprising the one or more resource records comprising the information associated with the third domain name.

17. The method of claim 16, wherein the second domain name corresponds to a parent zone, wherein the parent zone has a plurality of child zones, and wherein the obtaining of the one or more resource records comprises obtaining the one or more resource records from a zone file for one of the plurality of child zones.

18. The method of claim 17, wherein the obtaining of the one or more resource records comprises identifying the one of the plurality of child zones based on the at least one domain name label.

19. The method of claim 18, wherein a left-most label of the one of the plurality of child zones corresponds to one or more of the at least one domain name labels.

20. A method of processing data using a hierarchical domain name system, the method comprising:
causing a plurality of child zones of a parent zone to be created;
causing information associated with a given domain name to be stored in a zone file for one of the plurality of child zones, a left-most label of the one of the plurality of child zones comprising data derived based on the given domain name having been processed using a domain name distribution operation;
causing, for each of the plurality of child zones, a plurality of further child zones to be created; and
causing the information associated with the given domain name to be stored in a zone file for one of the plurality of further child zones, a left-most label of the one of the plurality of further child zones comprising data derived based on the given domain name having been processed using the domain name distribution operation.
